(19) United States
(12) Patent Application Publication
(10) Pub. No.: US 2026/0138425 A1
(43) Pub. Date: May 21, 2026

(54) VEHICLE ROOF WITH MANUALLY CONFIGURABLE SLIDING PANELS

(71) Applicant: Ford Global Technologies, LLC, Dearborn, MI (US)

(72) Inventors: Michael John Harmon, Northville, MI (US); Robert J. Gelardi, Plymouth, MI (US); Darren Luke, West Bloomfield, MI (US); Daniel J. Kangas, Livonia, MI (US); Justin Sorum, Royal Oak, MI (US); Abbas Ghamlouche, Dearborn, MI (US)

(21) Appl. No.: 18/950,886

(22) Filed: Nov. 18, 2024

(51) Int. Cl. B60J 7/04; B60J 7/057

(52) U.S. Cl. CPC B60J 7/042; B60J 7/057

(57) ABSTRACT

A motor vehicle may include a roof including a roof opening. The motor vehicle may also include a panel manually configurable between a fully closed position, an intermediate position, and at least one open position. The panel may be coupled to a link, and the link may be configured to rotate relative to the roof opening to move the panel between the intermediate and fully closed positions. The link may further be configured to slide relative to the roof opening to move the panel to the at least one open position.

### TECHNICAL FIELD

This disclosure relates to a motor vehicle including a roof with manually configurable sliding panels.

### BACKGROUND

Motor vehicles, including sport utility vehicles (SUVs), are known to include roofs that incorporate roof openings. These roof openings are configured be selectively uncovered, enabling passengers to enjoy the air and natural elements while maintaining the option for full coverage when needed.

### SUMMARY

In some aspects, the techniques described herein relate to a motor vehicle, including: a roof including a roof opening; and a panel manually configurable between a fully closed position, an intermediate position, and at least one open position, wherein the panel is coupled to a link, wherein the link is configured to rotate relative to the roof opening to move the panel between the intermediate and fully closed positions, and wherein the link is configured to slide relative to the roof opening to move the panel to the at least one open position.

In some aspects, the techniques described herein relate to a motor vehicle, wherein: the panel is a first panel, the link is a first link, the motor vehicle further includes a second panel manually configurable between a fully closed position, an intermediate position, and at least one open position, and the second panel is coupled to a second link configured to rotate relative to the roof opening to move the second panel between the intermediate and fully closed positions, and the second link is configured to slide relative to the roof opening to move the second panel to the at least one open position.

In some aspects, the techniques described herein relate to a motor vehicle, wherein a height dimension of the first link is greater than a height dimension of the second link.

In some aspects, the techniques described herein relate to a motor vehicle, wherein, when the first and second panels are in respective fully closed positions, the first and second panels together fully cover the roof opening.

In some aspects, the techniques described herein relate to a motor vehicle, wherein the first panel is configurable into a first open position in which the first panel substantially vertically overlaps the second panel.

In some aspects, the techniques described herein relate to a motor vehicle, wherein, when the first panel is in the first open position, the second panel is configurable into the intermediate position.

In some aspects, the techniques described herein relate to a motor vehicle, wherein, when the first panel is in the first open position and the second panel is in the intermediate position, the first and second panels are slidable to a fully open position in which only a portion of the first panel and only a portion of the second panel overlaps the roof opening.

In some aspects, the techniques described herein relate to a motor vehicle, wherein, when the first panel is in the first open position and the second panel is in the intermediate position, sliding of the first panel toward the fully open position results in sliding of the second panel toward the fully open position.

In some aspects, the techniques described herein relate to a motor vehicle, wherein the first panel includes a slide handle configured to be grasped by a user.

In some aspects, the techniques described herein relate to a motor vehicle, wherein the slide handle is configured to contact the second panel when the first panel is in the first open position and the second panel is in the intermediate position, such that sliding of the first panel toward the fully open position results in sliding of the second panel toward the fully open position.

In some aspects, the techniques described herein relate to a motor vehicle, wherein: the panel includes a first attachment pin projecting from a first side of the panel and connected to the link, the link is connected to a first track pin, the panel includes a second attachment pin projecting from a second side of the panel opposite the first side and connected to a second link, a first track adjacent a first side of the roof opening receives the first track pin, and a second track adjacent a second side of the roof opening opposite the first side receives the second track pin.

In some aspects, the techniques described herein relate to a motor vehicle, wherein: the roof opening includes a first end, a second end opposite the first end, a first side extending between the first and second ends, and a second side opposite the first side and extending between the first and second ends, the first track extends along substantially the entire first side of the roof opening from a point adjacent the first end of the roof opening to a point beyond the second end of the roof opening, and the second track extends along substantially the entire second side of the roof opening from a point adjacent the first end of the roof opening to a point beyond the second end of the roof opening.

In some aspects, the techniques described herein relate to a motor vehicle, wherein: the panel is a first panel, the motor vehicle further includes a second panel manually configurable between a fully closed position, an intermediate position, and at least one open position, the second panel includes a third attachment pin projecting from a first side of the second panel and connected to a third link, the third link is connected to a third track pin, the second panel includes a fourth attachment pin projecting from a second side of the second panel opposite the first side and connected to a fourth link, wherein the first track includes a first channel and a second channel spaced-apart vertically from the first channel, wherein the second track includes a first channel and a second channel spaced-apart vertically from the first channel, wherein the first track pin projects into the first channel of the first track, and the second track pin projects into the first channel of the second track, and wherein the third track pin projects into the second channel of the first track, and the fourth track pin projects into the second channel of the second track.

In some aspects, the techniques described herein relate to a motor vehicle, wherein: the panel includes at least one lever rotatable between a first position and a second position, when the panel is in the fully closed position and the lever is in the first position, the lever is configured to prevent movement of the panel to the intermediate position, and when the panel is in the fully closed position and the lever is in the second position, the lever is configured to not interfere with movement of the panel to the intermediate position.

In some aspects, the techniques described herein relate to a motor vehicle, wherein a majority of the panel by surface area is transparent.

In some aspects, the techniques described herein relate to a motor vehicle, wherein: as the panel moves between the intermediate position and the fully closed positions, the link rotates relative to the roof opening without sliding along to the roof opening, and as the panel moves between the intermediate position and the at least one open position, the link slides along the roof opening without rotating relative to the roof opening.

In some aspects, the techniques described herein relate to a method, including: manually moving a panel from a fully closed position to an intermediate position by rotating a link relative to a roof opening of a motor vehicle, wherein the link is coupled to the panel; and manually moving the panel from the intermediate position to an open position by sliding the link relative to the roof opening.

In some aspects, the techniques described herein relate to a method, wherein: the panel is a first panel, the link is a first link, the method includes manually moving a second panel from a fully closed position to an intermediate position by rotating a second link coupled relative to the roof opening, the second link is coupled to the second panel, and the method further includes manually moving the second panel from the intermediate position to an open position by sliding the second link relative to the roof opening.

In some aspects, the techniques described herein relate to a method, wherein a height dimension of the first link is greater than a height dimension of the second link.

In some aspects, the techniques described herein relate to a method, wherein: as the panel moves between the intermediate position and the fully closed positions, the link rotates relative to the roof opening without sliding along to the roof opening, and as the panel moves between the intermediate position and the open position, the link slides along the roof opening without rotating relative to the roof opening.

### BRIEF DESCRIPTION OF THE DRAWINGS

FIG. 1 illustrates a front perspective view of an example motor vehicle, which in this example is an SUV.

FIG. 2 is a top perspective view of a roof of the motor vehicle, with sliding panels are arranged such that a roof opening is in a fully covered configuration.

FIG. 3 is a view similar to FIG. 2, with the sliding panels arranged such that the roof opening is in a first partially uncovered configuration.

FIG. 4 is a view similar to FIG. 2, with the sliding panels arranged such that the roof opening is in a second partially uncovered configuration.

FIG. 5 is a view, from an interior of the motor vehicle, of the sliding panels. In FIG. 5, a first sliding panel is in an intermediate position.

FIG. 6 illustrates, without the remainder of the motor vehicle, first and second tracks relative to the panel.

FIG. 7 illustrates an example link and further illustrates additional detail of one of the tracks.

FIG. 8 is a view, from an interior of the motor vehicle, of the sliding panels in the configuration of FIG. 2.

FIG. 9 illustrates an example lever.

FIG. 10 is a view similar to FIG. 2, with the first sliding panel in an intermediate position.

FIG. 11 is a view similar to FIG. 2, with the first sliding panel and a second sliding panel in respective intermediate positions.

FIG. 12 is a view of the sliding panels in the configuration of FIG. 4 relative to a roof rack.

### DETAILED DESCRIPTION

This disclosure relates to a motor vehicle including a roof with manually configurable sliding panels. Among other benefits, this disclosure allows a user to arrange the roof in a custom configuration to expose a desired portion of the passenger compartment to the elements. Further, the roof is configurable by hand, without the use of electrically powered equipment or tools.

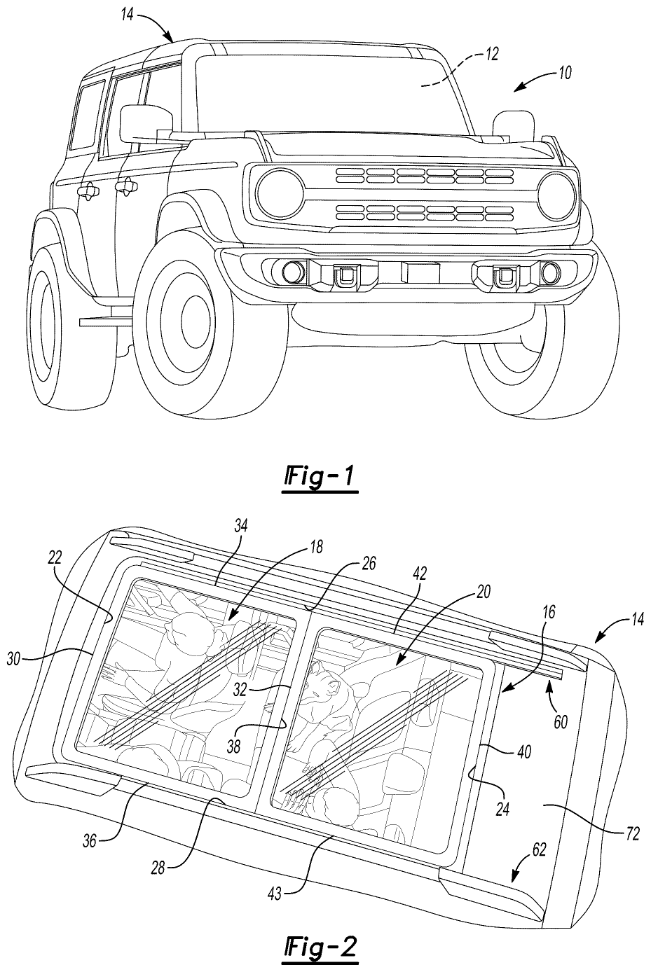

FIG. 1 illustrates a motor vehicle 10 (“vehicle 10”), which in this example is a sport utility vehicle (SUV). While an SUV is shown, the vehicle 10 could be another type of vehicle.

The vehicle 10 includes a passenger compartment, or passenger cabin, 12. A roof 14 is vertically above the passenger compartment 12. The roof 14 is defined by a body and/or a frame of the vehicle 10, and is generally configured to cover the passenger compartment 12 to protect the occupants from the weather and other elements.

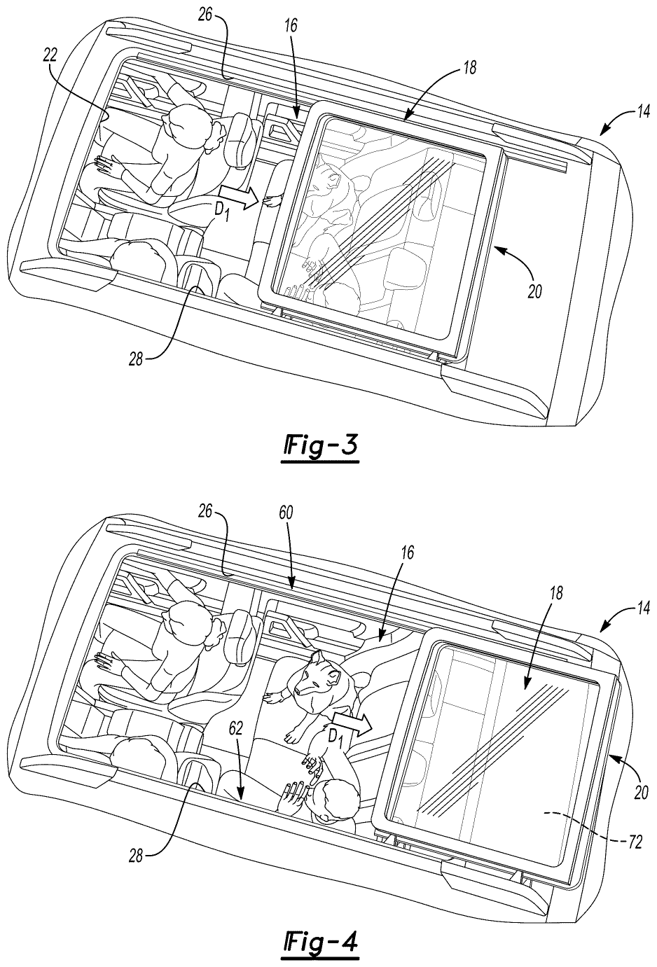

With reference to FIG. 2, the roof 14 includes a roof opening 16. The roof opening 16 is fully covered by first and second panels 18, 20, in FIG. 2. The panels 18, 20 are manually configurable to at least one open position in which the panels 18, 20 do not cover at least a portion of the roof opening 16. Two example open positions are shown in FIGS. 3 and 4. In FIG. 2, the panels 18, 20 are arranged such that the roof opening 16 is in a fully covered configuration. In FIG. 3, the panels 18, 20 are arranged such that the roof opening 16 is in a first partially uncovered configuration. In FIG. 4, the panels 18, 20 are arranged such that the roof opening 16 is in a second partially uncovered configuration in which a greater area of the roof opening 16 is uncovered by the panels 18, 20 than in the first partially uncovered configuration.

The roof opening 16 is defined between a first end 22, a second end 24 opposite the first end 22, a first side 26 extending between the first and second ends 22, 24, and a second side 28 opposite the first side 26 and extending between the first and second ends 22, 24. The roof opening 16 is substantially rectangular in this example. The roof opening 16 exhibits an area within a range of 65-85% of the area of the roof 14 (inclusive of the roof opening 16). An elastomeric seal may extend about the entire perimeter of the roof opening 16. When the panels 18, 20 are configured as in FIG. 2, the panels 18, 20 may be held in contact with the elastomeric seal to resist ingress of water, dirt, etc., relative to the passenger compartment 12.

In this disclosure, at least one panel is manually configurable between a fully closed position, an intermediate position, and at least one open position. In the at least one open position, at least a portion of the roof opening 16 is uncovered by the at least one panel.

In the embodiment of FIG. 2, the vehicle 10 includes first panel 18 and second panel 20. Each of the first and second panels 18, 20 are coupled to at least one link, which is configured to facilitate movement of the first and second panels 18, 20 relative to the roof opening 16.

With reference to the configuration of FIG. 2, the first panel 18 is arranged forward of the second panel 20. The “forward” direction is used herein with reference to a normal orientation of a motor vehicle. The first panel 18 includes a first end 30, a second end 32 opposite the first end 30, a first side 34 extending between the first and second ends 30, 32, and a second side 36 opposite the first side 34 and extending between the first and second ends 30, 32. In this example, a majority of a surface area of the panel 18 is transparent. In particular, a majority of the surface area of the panel 18 is provided by glass.

The second panel 20 includes a first end 38, a second end 40 opposite the first end 38, a first side 42 extending between the first and second ends 38, 40, and a second side 43 opposite the first side 42 and extending between the first and second ends 38, 40. In this example, a majority of a surface area of the panel 20 is transparent. In particular, a majority of the surface area of the panel 20 is provided by glass.

The first and second panels 18, 20 are substantially similarly-sized in this example. In particular, when the first and second panels 18, 20 are in the configuration of FIG. 2, the first panel 18 covers substantially 50% of the area of the roof opening 16, and the second panel covers substantially 50% of the area of the roof opening 16. The first and second panels 18, 20 may be differently-sized in other examples.

With reference to FIG. 5, each of the panels 18, 20 is coupled to a plurality of links. The first panel 18 is coupled to first and second links 44, 46 adjacent first side 34, and is further coupled to third and fourth links 48, 50 adjacent second side 36. The second panel 20 is coupled to first and second links 52, 54 adjacent first side 42, and is further coupled to third and fourth links 56, 58 adjacent second side 43.

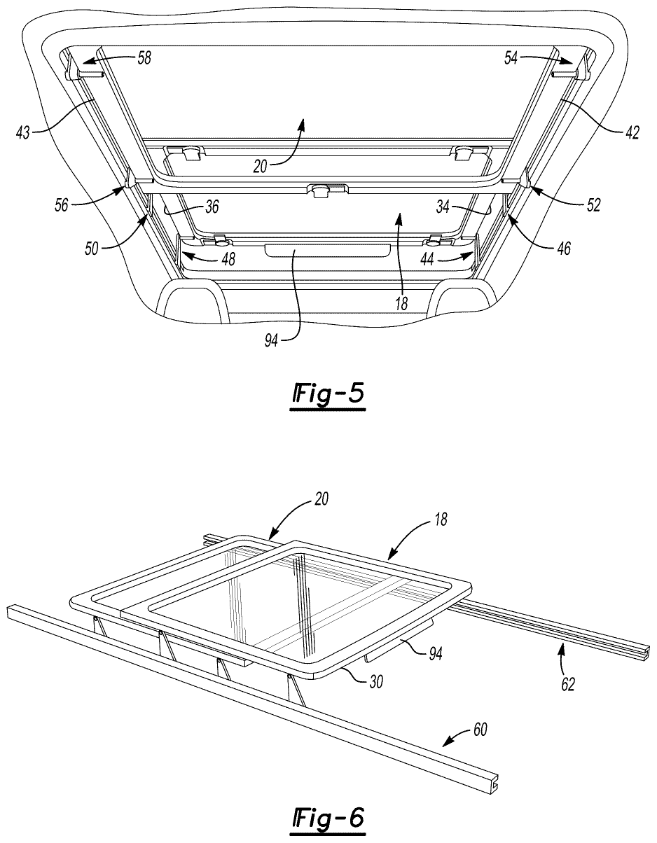

With reference to FIG. 4 and FIG. 6, the vehicle 10 includes a first track 60 and a second track 62. The first track 60 may be attached adjacent to, or integrated into, the first side 26 of the roof opening 16, and the second track 62 may be attached adjacent to, or integrated into, the second side 28 of the roof opening 16. In an embodiment, each of the tracks 60, 62, includes first and second channels, with each channel being substantially U-shaped in cross-section, open facing toward the panels 18, 20. For example, track 62 includes a first channel 64 and a second channel 66 vertically spaced-apart from the first channel 64. In particular, the first channel 64 is vertically above the second channel 66.

Additional detail of the link 48, and the arrangement of the panel 18 relative to the link 48, will now be described. While the panel 18 and link 48 are described in detail, it should be understood that links 44, 46, 50 are arranged relative to panel 18 similarly, and the panel 20 is also arranged relative to links 52, 54, 56, 58 similarly, with some exceptions noted below.

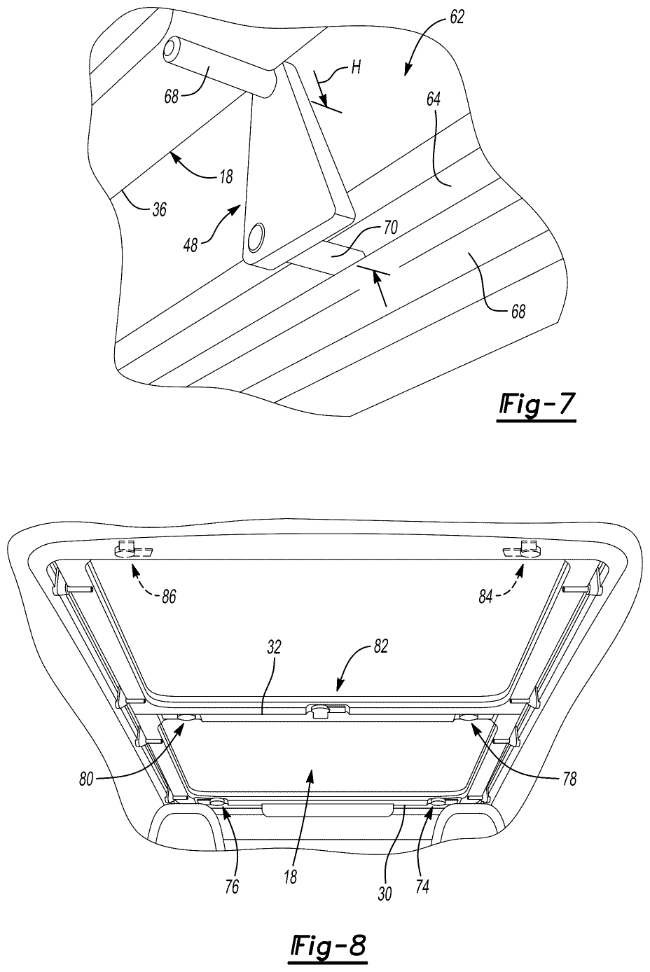

With reference to FIG. 7, the panel 18 includes an attachment pin 68 projecting from side 36 of the panel 18 and connected to the link 48. The link 48 is further connected to a track pin 70. Attachment pin 68 and track pin 70 are arranged on generally opposite sides of the link 48. The attachment pin 68 is spaced-apart from the track-pin by a height dimension H. The link 48 is rotatable about the longitudinal axes of both the attachment pin 68 and the track pin 70. The track pin 70 may be a bearing pin. The track pin 70 may include rollers in an example.

The track pin 70 is received in channel 64. The track pins of links 44, 46, and 50 are also received in channel 64. The track pins of links 52, 54, 56, 58 are received in channel 66 to avoid interference with links 44, 46, 48, 50, in this example. Further, a height dimension H of the links 52, 54, 56, 58 is less than the height dimension H of links 44, 46, 48, 50, in one example, to further avoid interference between panels 18, 20. Additionally, links 52, 54, 56, 58 may be spaced-apart inward of tracks 60, 62 by a greater distance than links 44, 46, 48, 50, again to avoid interference between the links and panels 18, 20.

In this disclosure, the panels 18, 20 are configured to slide along tracks 60, 62. In order to increase the amount of roof opening 16 that can be uncovered, the tracks 60, 62 extend along substantially the entire respective side 26, 28 of the roof opening 16 from a point adjacent the first end 22 of the roof opening 16 to a point beyond (i.e., spaced-apart rearward of) the second end 24 of the roof opening 16. Therefore, when the panels 18, 20 are configured as in FIG. 4, the panels 18, 20 at least partially cover a portion 72 of the roof 14 that is rearward of the roof opening 16.

The panels 18, 20 each include one or more levers configured to hold the panels 18, 20 relative to the roof 14 and/or another one of the panels 18, 20. With reference to FIG. 8, panel 18 includes a first lever 74 and a second lever 76 adjacent end 30. The panel 18 further includes a third lever 78 and a fourth lever 80 adjacent end 32. The panel 20 includes a lever 82 adjacent end 38, and levers 84, 86 (shown in phantom) adjacent end 40. Lever 82 is laterally between levers 78, 80. Levers 74, 76 are manually rotatable, by a user by hand and without tools, to selectively engage the panel 18 with a portion of the roof 14 adjacent end 22. Levers 78, 80 are manually rotatable to selectively engage the panel 18 with the panel 20. Lever 82 is manually rotatable to selectively engage the panel 20 with the panel 18. Further, levers 84, 86 are manually rotatable to selectively engage the panel 20 with a portion of the roof 14 adjacent end 24. While a particular number and configuration of levers has been shown and described, this disclosure extends to vehicles with a different quantity and configuration of levers. For instance, the levers could be coupled to the roof 14 as opposed to the panels.

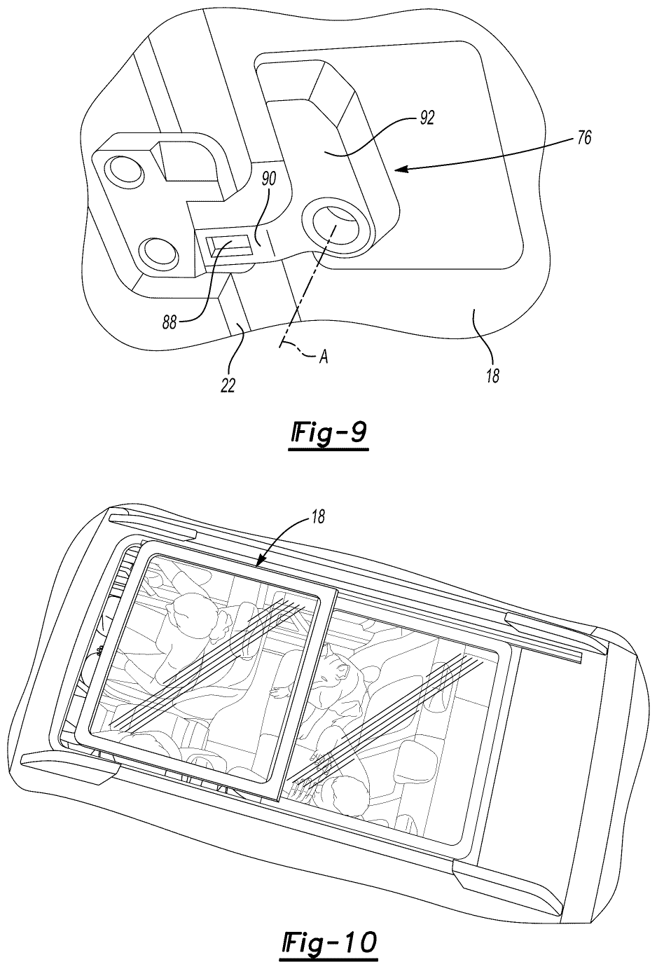

The lever 74 is shown in detail in FIG. 9. The lever 74 is representative of the arrangement of the other levers 76, 78, 80, 82, 84, 86. Lever 74 is engaged with a portion 88 of the roof 14 adjacent end 22 in this example. Specifically, lever 74 includes a first arm 90 and a second arm 92. The first arm 90 may include a cam surface configured to engage a corresponding surface of portion 88. The second arm 92 is configured as a handle and is able to be grasped by a user. A user can grasp second arm 92 to rotate the lever 74 about axis A, such that the first arm 90 comes selectively into and out of engagement with portion 88. In the configuration of FIG. 9, the lever 74 is configured to prevent vertical movement of panel 18. When the lever 74 is rotated such that the first arm 90 does not contact the portion 88, such as when the lever 74 is rotated substantially 90° about axis A relative to configuration in FIG. 9, the lever 74 is configured to not interfere with vertical movement of the panel 18.

In an aspect of this disclosure, the first panel 18 includes a slide handle 94 (FIGS. 5 and 6) configured to be grasped by a user. The slide handle 94 projects downward from a point adjacent end 30. The slide handle 94 is also configured to contact end 38 of panel 20 to transfer sliding movement of the first panel 18 into sliding movement of the second panel 20.

An example sequence for manually configuring the roof 14 will now be described. In the example sequence, the roof opening 16 is fully covered by the panels 18, 20, as shown in FIG. 2. In FIG. 2, the panels 18, 20 are in respective fully closed positions. In the fully closed positions, levers 74, 76, 78, 80, 82, 84, and 86 are engaged with their respective adjacent structures, to prevent movement of the panels 18, 20 out of the fully closed position.

Next, the levers 74, 76, 78, 80, and 82 are rotated by a user, by hand, such that the levers 74, 76, 78, 80, and 82 are moved out of engagement with their respective adjacent structures. With the levers so configured, the first panel 18 is able to move to an intermediate position, as shown in FIG. 10. To move to the intermediate position, force is applied upward on first panel 18, resulting in rotation of links 44, 46 48, 50 and vertically upward movement of the first panel 18. The force may be applied to the first panel 18 by a user, or by a spring or other biasing device, or both. In particular, the links 44, 46 48, 50 rotate without sliding relative to the tracks 60, 62 when the first panel 18 moves from the fully closed position to the intermediate position.

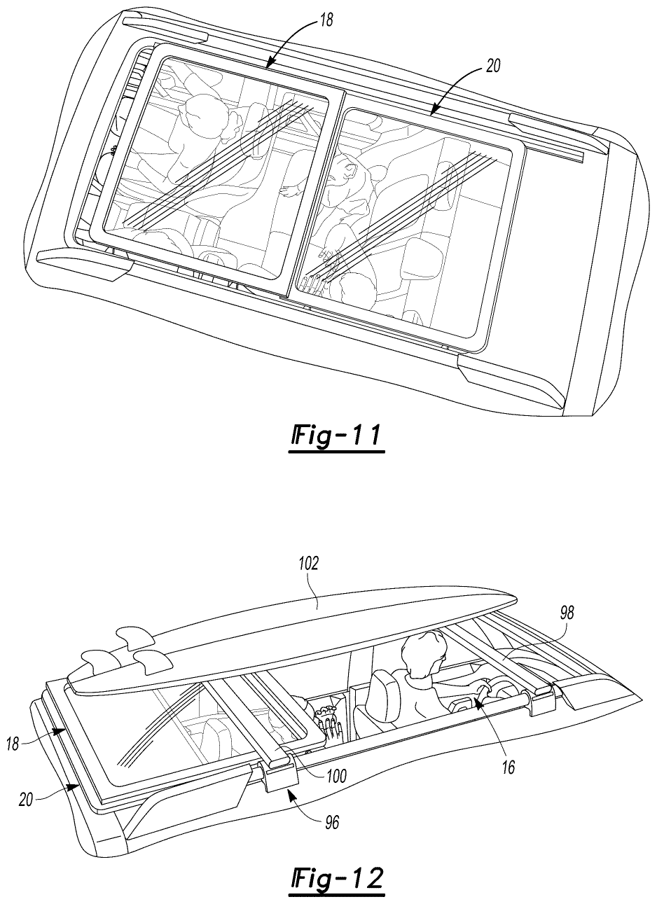

Next, levers 84 and 86 are moved out of engagement with their respective adjacent structures, which permits the second panel 20 to move from the fully closed position to an intermediate position, as shown in FIG. 11. To move the intermediate position, force is applied upward on panel 20, resulting in rotation of links 52, 54, 56, 58 and vertically upward movement of the panel 20. The force may be applied to the second panel 20 by a user, or by a spring or other biasing device, or both. In particular, the links 52, 54, 56, 58 rotate without sliding relative to the tracks 60, 62 when the second panel 20 moves from the fully closed position to the intermediate position. Due to the arrangement of the track pins of the respective panels 18, 20 in different channels, and/or the height dimension H of the respective links of the panels 18, 20, the panel 20 is vertically below the panel 18.

From the position of FIG. 11, a sliding force is applied to the panel 18 in direction D1 (FIG. 3), such as by a user applying a force to slide handle 94, which causes the panel 18 and links 44, 46, 48, 50 to slide relative to the tracks 60, 62 to the position of FIG. 3. In FIG. 3, the first panel 18 is in a first open position in which the first panel 18 substantially vertically overlaps the second panel 20. In FIG. 3, the second panel 20 has not slid along the tracks 60, 62 relative to the intermediate position of second panel 20. The second panel 20 could be moved between the intermediate and fully closed positions with the panel 18 configured as shown in FIG. 3. Detents or other retention mechanisms may selectively hold the panels 18, 20 in the configuration of FIG. 3.

From the configuration of FIG. 3, continued sliding force applied to the first panel 18 in direction D1 results in movement of both panels 18, 20 to a fully open position in which only a portion of the first panel 18 and only a portion of the second panel 20 overlaps the roof opening 16, as shown in FIG. 4. Detents or other retention mechanisms may selectively hold the panels 18, 20 in the configuration of FIG. 4.

Because of the relatively low profile of the panels 18, 20, the panels 18, 20 are configurable between the fully closed position (FIG. 2) and the at least one open position (FIGS. 3 and 4) without interfering with a roof rack 96 (FIG. 12), even when the roof rack 96 includes cross-bars 98, 100, which may or may not support gear 102 thereon, vertically overlapping the roof opening 16.

Reference to the panels 18, 20 being manually configurable means the panels 18, 20 are able to be configured between the fully closed and various open positions without powered electrical components, such as motors, drives, actuators, etc., and further refers to the panels 18, 20 being configurable by a user by hand and without the use of tools such as screwdrivers, drills, wrenches, etc.

It should be understood that terms such as “about,” “substantially,” and “generally” are not intended to be boundaryless terms, and should be interpreted consistent with the way one skilled in the art would interpret those terms. Further, directional terms such as “upper,” “forward,” “rearward,” “upward,” “downward,” “vertical,” “horizontal,” “below,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a roof including a roof opening; and
a panel manually configurable between a fully closed position, an intermediate position, and at least one open position, wherein the panel is coupled to a link, wherein the link is configured to rotate relative to the roof opening to move the panel between the intermediate and fully closed positions, and wherein the link is configured to slide relative to the roof opening to move the panel to the at least one open position.

2. The motor vehicle as recited in claim 1, wherein:
the panel is a first panel,
the link is a first link,
the motor vehicle further includes a second panel manually configurable between a fully closed position, an intermediate position, and at least one open position, and
the second panel is coupled to a second link configured to rotate relative to the roof opening to move the second panel between the intermediate and fully closed positions, and the second link is configured to slide relative to the roof opening to move the second panel to the at least one open position.

3. The motor vehicle as recited in claim 2, wherein a height dimension of the first link is greater than a height dimension of the second link.

4. The motor vehicle as recited in claim 2, wherein, when the first and second panels are in respective fully closed positions, the first and second panels together fully cover the roof opening.

5. The motor vehicle as recited in claim 2, wherein the first panel is configurable into a first open position in which the first panel substantially vertically overlaps the second panel.

6. The motor vehicle as recited in claim 5, wherein, when the first panel is in the first open position, the second panel is configurable into the intermediate position.

7. The motor vehicle as recited in claim 6, wherein, when the first panel is in the first open position and the second panel is in the intermediate position, the first and second panels are slidable to a fully open position in which only a portion of the first panel and only a portion of the second panel overlaps the roof opening.

8. The motor vehicle as recited in claim 7, wherein, when the first panel is in the first open position and the second panel is in the intermediate position, sliding of the first panel toward the fully open position results in sliding of the second panel toward the fully open position.

9. The motor vehicle as recited in claim 8, wherein the first panel includes a slide handle configured to be grasped by a user.

10. The motor vehicle as recited in claim 9, wherein the slide handle is configured to contact the second panel when the first panel is in the first open position and the second panel is in the intermediate position, such that sliding of the first panel toward the fully open position results in sliding of the second panel toward the fully open position.

11. The motor vehicle as recited in claim 1, wherein:
the panel includes a first attachment pin projecting from a first side of the panel and connected to the link,
the link is connected to a first track pin,
the panel includes a second attachment pin projecting from a second side of the panel opposite the first side and connected to a second link,
a first track adjacent a first side of the roof opening receives the first track pin, and
a second track adjacent a second side of the roof opening opposite the first side receives the second track pin.

12. The motor vehicle as recited in claim 11, wherein:
the roof opening includes a first end, a second end opposite the first end, a first side extending between the first and second ends, and a second side opposite the first side and extending between the first and second ends,
the first track extends along substantially the entire first side of the roof opening from a point adjacent the first end of the roof opening to a point beyond the second end of the roof opening, and
the second track extends along substantially the entire second side of the roof opening from a point adjacent the first end of the roof opening to a point beyond the second end of the roof opening.

13. The motor vehicle as recited in claim 12, wherein:
the panel is a first panel,
the motor vehicle further includes a second panel manually configurable between a fully closed position, an intermediate position, and at least one open position,
the second panel includes a third attachment pin projecting from a first side of the second panel and connected to a third link,
the third link is connected to a third track pin,
the second panel includes a fourth attachment pin projecting from a second side of the second panel opposite the first side and connected to a fourth link,
wherein the first track includes a first channel and a second channel spaced-apart vertically from the first channel,
wherein the second track includes a first channel and a second channel spaced-apart vertically from the first channel,
wherein the first track pin projects into the first channel of the first track, and the second track pin projects into the first channel of the second track, and
wherein the third track pin projects into the second channel of the first track, and the fourth track pin projects into the second channel of the second track.

14. The motor vehicle as recited in claim 1, wherein:
the panel includes at least one lever rotatable between a first position and a second position,
when the panel is in the fully closed position and the lever is in the first position, the lever is configured to prevent movement of the panel to the intermediate position, and
when the panel is in the fully closed position and the lever is in the second position, the lever is configured to not interfere with movement of the panel to the intermediate position.

15. The motor vehicle as recited in claim 1, wherein a majority of the panel by surface area is transparent.

16. The motor vehicle as recited in claim 1, wherein:
as the panel moves between the intermediate position and the fully closed positions, the link rotates relative to the roof opening without sliding along to the roof opening, and
as the panel moves between the intermediate position and the at least one open position, the link slides along the roof opening without rotating relative to the roof opening.

17. A method, comprising:
manually moving a panel from a fully closed position to an intermediate position by rotating a link relative to a roof opening of a motor vehicle, wherein the link is coupled to the panel; and
manually moving the panel from the intermediate position to an open position by sliding the link relative to the roof opening.

18. The method as recited in claim 17, wherein:
the panel is a first panel,
the link is a first link,
the method includes manually moving a second panel from a fully closed position to an intermediate position by rotating a second link coupled relative to the roof opening,
the second link is coupled to the second panel, and
the method further includes manually moving the second panel from the intermediate position to an open position by sliding the second link relative to the roof opening.

19. The method as recited in claim 18, wherein a height dimension of the first link is greater than a height dimension of the second link.

20. The method as recited in claim 17, wherein:
as the panel moves between the intermediate position and the fully closed positions, the link rotates relative to the roof opening without sliding along to the roof opening, and
as the panel moves between the intermediate position and the open position, the link slides along the roof opening without rotating relative to the roof opening.
